(19) United States
(12) Patent Application Publication
(10) Pub. No.: US 2008/0201244 A1
(43) Pub. Date: Aug. 21, 2008

(54) Network-facilitated central storage/shipping/cleaning and maintenance service for frequent travelers and method thereof

(76) Inventor: Katherine Johnson, Cumming, GA (US)

Correspondence Address: MYERS & KAPLAN;INTELLECTUAL PROPERTY LAW, L.L.C., CUMBERLAND CENTER II, 3100 CUMBERLAND BLVD , SUITE 1400, ATLANTA, GA, 30339, US

(21) Appl. No.: 11/706,505

(22) Filed: Feb. 15, 2007

(51) Int. Cl. G06Q 10/00

(52) U.S. Cl. 705/28

(57) ABSTRACT

An Internet-facilitated storage, shipping, cleaning and maintenance service and method thereof, wherein the repeated, time-consuming management and organization of personal belongings, the burdensome process of packing, and the increasingly complicated chore of carrying and/or checking luggage may be essentially eliminated.

### COPYRIGHT NOTICE

A portion of the disclosure of this patent document contains material which is subject to copyright protection. The copyright owner has no objection to the facsimile reproduction by anyone of the patent document or patent disclosure as it appears in the U.S. Patent and Trademark Office patent file or records, but otherwise reserves all copyright rights whatsoever.

### TECHNICAL FIELD

The present invention relates generally to storage and delivery services and associated methods, and more specifically to an Internet-facilitated storage, shipping, cleaning and maintenance service and method thereof. The present invention is particularly suitable for, although not strictly limited to, utilization by and for frequent business travelers, wherein the repeated, time-consuming management and organization of personal belongings, the burdensome process of packing, and the increasingly complicated chore of carrying and/or checking luggage may be essentially eliminated.

### BACKGROUND OF THE INVENTION

Frequent travelers abound. Some regularly travel for pleasure, as a hobby. Most frequent travelers, however, are business travelers. Many log hundreds of thousands of air miles each year, effectively commuting by airplane from their homes to hotels, conference centers, and other temporary residence locations. For those individuals, especially those returning to their homes only for the weekends, the tiresome process of packing, unpacking, and caring for their personal belongings can, unfortunately, dominate the time spent at home. For example, laundering of clothing typically must be completed in order to prepare for a subsequent trip.

Moreover, time constraints during the “changeover” period can render these home activities rushed and disorganized. This can result in an inability to locate items for repacking, a failure of adequate preparation thereby rendering some items unavailable for repacking, and/or an increase in forgotten necessities. Also, the frequent traveler may find himself or herself rushing off on a subsequent trip, leaving unwashed clothing and personal belongings still within the previous week's luggage, or scattered about, awaiting the next return home to cluttered surroundings.

Even for the most organized, travel has become increasingly difficult due to the current state of world affairs and resultant baggage requirements and limitations. Security checkpoints, screening, and searches result in increased time spent in airports and terminals by all travelers, but especially those checking luggage and/or personally carrying baggage. Many airports no longer offer curbside check-in. Lines for baggage check-in and screening can be extremely long, especially during peak travel periods for business travelers, such as Monday mornings and Friday afternoons, in addition to holidays. Further, U.S. domestic airlines lose up to 10,000 bags per day, and, even upon arrival at a destination, the wait required for retrieval of luggage at baggage claim is frequently lengthy, with uncomfortably crowded conditions.

Therefore, it is readily apparent that there is a need for an organization and inventory system for personal belongings, wherein off-site storage and maintenance alleviates the burden of hands-on care obligations, wherein network-based operation facilitates easy access from virtually any location, and wherein personal concierge-style shipping and delivery services minimize the quantity of luggage, checked and hand-carried, for travelers.

### BRIEF SUMMARY OF THE INVENTION

Briefly described, in a preferred embodiment, the present invention overcomes the above-mentioned disadvantages and meets the recognized need for such a system and method by providing an Internet-facilitated storage, shipping, cleaning and maintenance service and method thereof, wherein the repeated, time-consuming management and organization of personal belongings, the burdensome process of packing, and the increasingly complicated chore of carrying and/or checking luggage may be essentially eliminated.

According to its major aspects and broadly stated, the present invention in its preferred form is a system and method comprising a storage facility for receiving personal belongings such as, for exemplary purposes only, toiletries, suits, ties, undergarments, overcoats, boots, shoes, golf clubs, skis, skiwear, and the like; goods and services providers such as, for exemplary purposes only, dry cleaners, drugstores, markets, pro-shops and the like, for cleaning, maintaining, and/or providing a source of personal belongings; packing and shipping professionals for organizing containers of personal belongings and arranging for delivery to and from a selected location; and an Internet-based portal enabling virtual access to and control over personal belongings, wherein selection of items, time and location for delivery may occur, direction of cleaning, maintenance, and storage parameters may be defined, and restocking of items into personal belonging inventory may occur.

More specifically, the present invention is a network-facilitated central storage, shipping, cleaning and maintenance service for frequent travelers, wherein a user, likely a business traveler, stores a variety of travel-necessary belongings in a central storage facility. When a trip is pending, the user visits a secure website, wherein he has a personal “virtual closet,” and selects the items from his stored belongings that he would like to have on the trip. The selected items are virtually “removed” from the user's virtual closet, physically removed from the storage facility, and packed and shipped to the appropriate hotel or conference center to coincide with the user's arrival. For return, the user simply return ships the items back to the storage facility, the items returned are cleaned and maintained pursuant to the user's directions, and then replaced in the virtual closet, remaining ready for his next travel.

In order to further enhance the benefits to a user of the present invention, an online storefront may be associated, wherein a user may make purchases. For example, a user may elect to purchase consumables, such as toiletries for a specific journey, or clothing, sporting goods, or other items to increase the inventory in his virtual closet, wherein depending upon the user's preference, the item(s) may be delivered directly to the storage facility and rendered accessible via the user's virtual closet, or the item(s) may be included in a pending shipment to a particular travel destination. The storefront may offer goods directly and/or may include links to known merchants and service provides.

Additionally, other services could be accessible for associated use with the user's virtual closet. Rental of infrequently required specialty items could be facilitated, wherein a user residing in a tropical environment, for example, could rent a heavy overcoat for a particular trip to a wintry destination; or specialty sports gear, such as ski or scuba equipment or golf clubs, could be rented, shipped and received along with the user's other personal belongings at a particular destination. Concierge-type services could also be provided via links to existing sources, such as, for exemplary purposes only, restaurant reservations and entertainment ticket purchases. Moreover, travel-related services could also be provided, for example, via links to hotel, rental car, limousine, and airline portals, and the like.

Accordingly, a feature and advantage of the present invention is its ability to reduce a frequent traveler's need to pack and repack for each trip.

Another feature and advantage of the present invention is its incorporation of a web-based portal and related software adapted to track and organize a user's personal belongings, to receive user directions regarding maintenance, care, and storage of each item, as required, and to coordinate shipping and other services as desired by the user.

Another feature and advantage of the present invention is its ability to provide a virtual closet and related physical storage facility, accessible from essentially any geographic location, wherein a user may remotely direct the cleaning, maintenance, and repair of personal belongings in order to efficiently ensure their continued availability for use.

Yet another feature and advantage of the present invention is its ability to assist a user with stocking and/or restocking his virtual closet and/or individual trip necessities.

Yet still another feature and advantage of the present invention is its ability to decrease the risk of loss and/or misdirection of belongings during travel.

Still another feature and advantage of the present invention is its ability to assist a user with coordinating travel-related services and destination activities in an easy and time-saving environment.

Yet another feature and advantage of the present invention is its ability to relieve frequent travelers from the repeated, time-consuming management and organization of personal belongings, the burdensome process of packing, and the increasingly complicated chore of carrying and/or checking luggage.

Still another feature and advantage of the present invention is its ability to store personal “base” selections for a given user, in order to alleviate the need to repeatedly pack essential items required for each trip, wherein a user can simply add items specific to a particular destination to his stored base selections when scheduling a trip.

Still yet another feature and advantage of the present invention is its ability to interrelate a network-based organization and inventory system for personal belongings, an off-site storage and maintenance facility, and shipping and delivery services.

Yet still another feature and advantage of the present invention is its ability to decrease the quantity of luggage, checked and hand-carried, by travelers, thereby decreasing security delays, easing strain on transportation workers, and benefiting airlines by decreasing related fuel costs.

Yet another feature and advantage of the present invention is its ability to potentially decrease risk to passenger-occupied transportation vehicles by enabling transport of a majority of passenger belongings in shipping containers via cargo vehicles, thereby potentially decreasing the volume of hand-carried and checked luggage, and the security risks associated therewith.

Still another feature and advantage of the present invention is the ability of the present invention to essentially relieve travelers of the increasingly complicated chore of carrying and/or checking luggage.

Yet another feature and advantage of the present invention is the ability of the present invention to enable a traveler to essentially pack for a trip and transport her luggage without any physical labor, wherein electronic interface direction is the traveler's only obligation.

These and other objects, features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a general flow diagram of a basic user initial interaction sequence for a network facilitated central storage/shipping/cleaning and maintenance service for frequent travelers, according to a preferred embodiment of the present invention;

FIG. 2 is a general flow diagram of basic provider initial interaction sequence for a network facilitated central storage/shipping/cleaning and maintenance service for frequent travelers, according to a preferred embodiment of the present invention;

FIG. 3 is a general flow diagram of basic trip-related service interactions for a network facilitated central storage/shipping/cleaning and maintenance service for frequent travelers, according to a preferred embodiment of the present invention;

FIG. 4 is a general flow diagram of user virtual activities via a network facilitated central storage/shipping/cleaning and maintenance service for frequent travelers, according to a preferred embodiment of the present invention;

FIG. 5 is a chart depicting the interrelationship of the plurality of services offered by the provider in a network facilitated central storage/shipping/cleaning and maintenance service for frequent travelers, according to a preferred embodiment of the present invention;

FIG. 6 is a web-portal user interface for a network facilitated central storage/shipping/cleaning and maintenance service for frequent travelers, according to a preferred embodiment of the present invention;

FIG. 7 is a user directive interface for a network facilitated central storage/shipping/cleaning and maintenance service for frequent travelers, according to a preferred embodiment of the present invention;

FIG. 8 is a virtual closet interface for a network facilitated central storage/shipping/cleaning and maintenance service for frequent travelers, according to a preferred embodiment of the present invention;

FIG. 9 is a user maintenance directive interface for a network facilitated central storage/shipping/cleaning and maintenance service for frequent travelers, according to a preferred embodiment of the present invention;

FIG. 10 is a user storefront selection interface for a network facilitated central storage/shipping/cleaning and maintenance service for frequent travelers, according to a preferred embodiment of the present invention;

FIG. 11 is a user storefront selection interface for a network facilitated central storage/shipping/cleaning and maintenance service for frequent travelers, according to a preferred embodiment of the present invention;

FIG. 12 is a user store interface for a network facilitated central storage/shipping/cleaning and maintenance service for frequent travelers, according to a preferred embodiment of the present invention;

FIG. 13 is a cyclical flow-diagram of a network facilitated central storage/shipping/cleaning and maintenance service for frequent travelers, according to a preferred embodiment of the present invention; and

FIG. 14 is an exemplary trip set selected by a user from a virtual closet of a network facilitated central storage/shipping/cleaning and maintenance service for frequent travelers, according to a preferred embodiment of the present invention.

### DETAILED DESCRIPTION OF THE PREFERRED AND ALTERNATIVE EMBODIMENTS

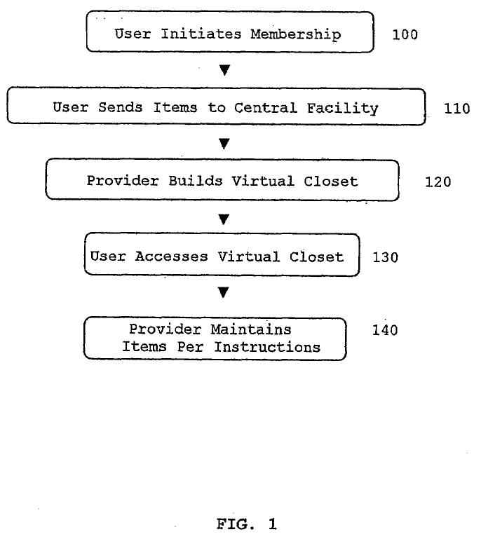

In describing the preferred and alternate embodiments of the present invention, as illustrated in FIGS. 1-14, specific terminology is employed for the sake of clarity. The invention, however, is not intended to be limited to the specific terminology so selected, and it is to be understood that each specific element includes all technical equivalents that operate in a similar manner to accomplish similar functions.

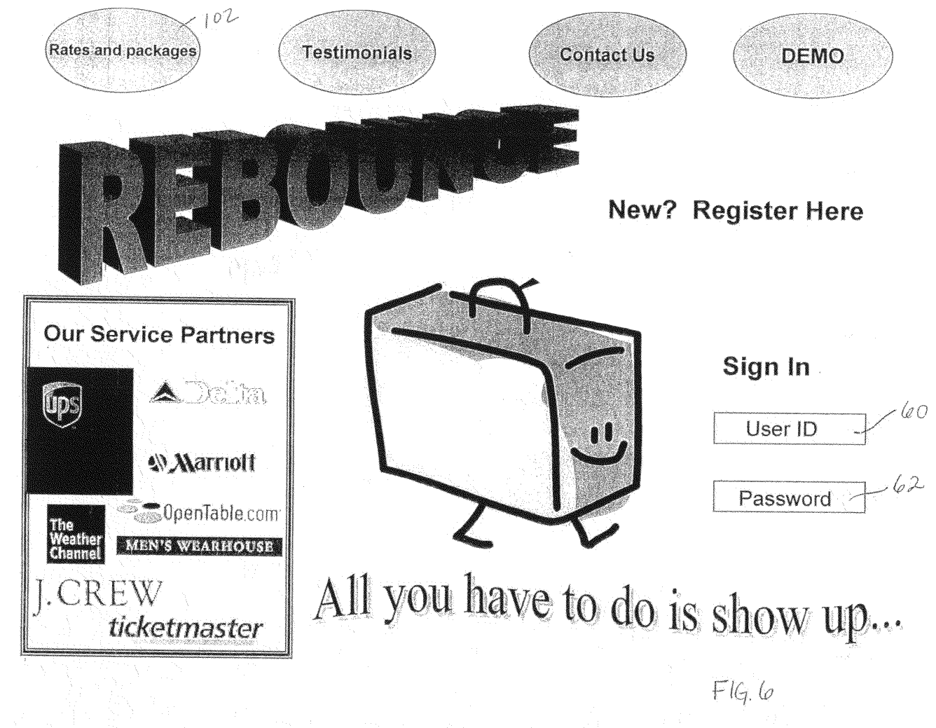

The present invention in a preferred embodiment is a system and method for Internet-facilitated central storage, shipping, cleaning and maintenance of belongings for frequent travelers 10, comprising storage facility 20, shipping provider 30, cleaning and maintenance coordinator 40, and web portal operator 50. Referring now to FIG. 1, a user preferably enters into a membership relationship 100 with a service provider, preferably via an electronic medium such as a worldwide networking system, for example, the Internet, as depicted in FIG. 6, wherein the user desires to participate in system and method for Internet-facilitated central storage, shipping, cleaning and maintenance of belongings for frequent travelers 10. Preferably, the user selects from a plurality of rate packages 102, wherein fees for system and method 10 are preferably based upon a flat periodic fee for fixed costs, and wherein additional fees are preferably based upon expenses generated by the user, such as for shipping fees, dry cleaning, purchase and/or rental of goods, and the like. One skilled in the art should readily recognize that the fee structure can vary, wherein essentially any format suitable and/or desirable could be utilized, and wherein third-party sponsorship could supplement and/or supplant individual user fees without departing from the intended scope of the present invention. Additionally, user participation could be linked to rewards from third-party service providers, such as, for example, airlines, in order to encourage minimized the need for personal luggage transport.

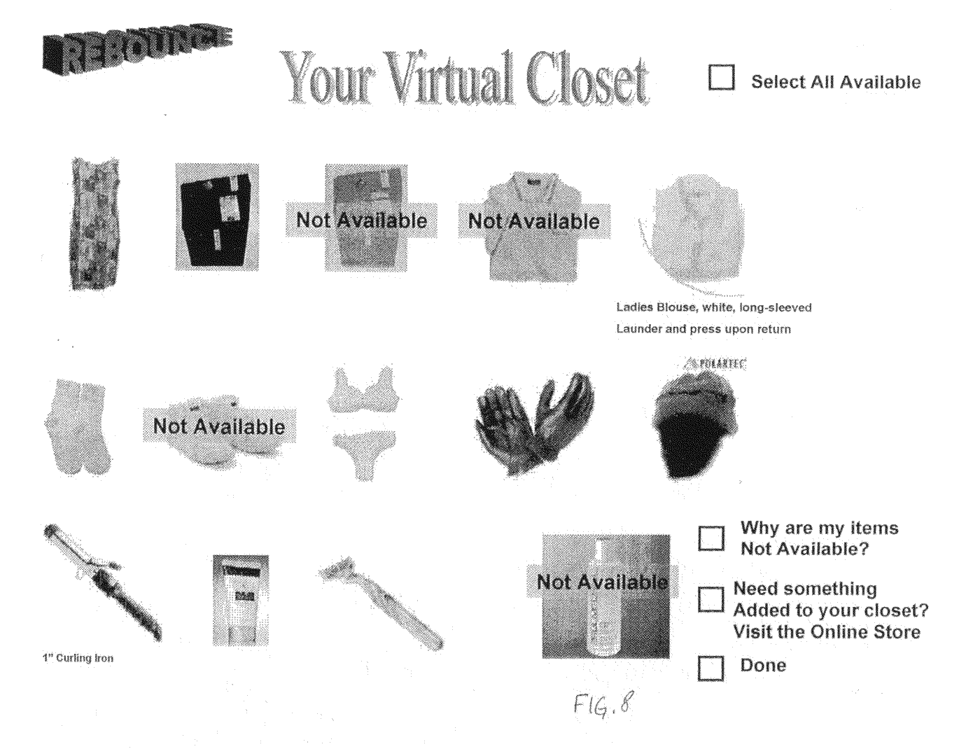

After commencing membership, in step 110, as shown in FIG. 1, the user preferably sends a variety of travel-necessary and/or travel-desired belongings to a central storage facility 20, including personal belongings such as, for exemplary purposes only, toiletries, suits, ties, undergarments, overcoats, boots, shoes, golf clubs, skis, skiwear, and the like. In step 120, the service provider receives the belongings and preferably builds a personalized inventory for the user. Preferably, each item is specifically logged-in to storage facility 20 and, preferably, according to step 125, each item is photographed for user-accessible display in the user's virtual closet, such as is depicted in FIG. 8, wherein the virtual closet is preferably a pictorial display of the user's personalized inventory along with a user-provided item description.

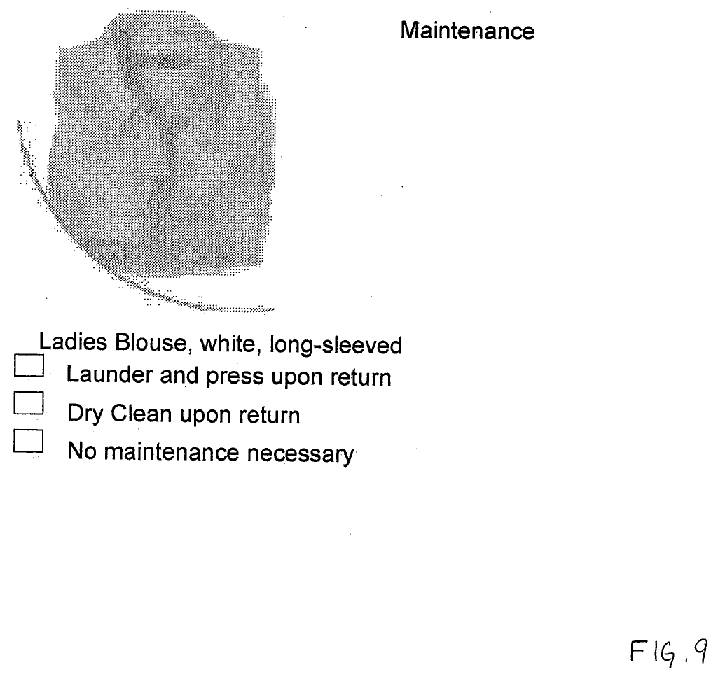

Following creation and posting of the user's personal inventory, according to step 130, the user preferably accesses the virtual closet, reviews the inventory, and preferably, for each item, provides directives, for cleaning and maintaining the item and parameters for storage, if necessary. FIG. 9 depicts an exemplary item with selectable cleaning parameters. As defined in step 140, the service provider physically maintains the user's personal belongings at storage facility 20, pending request from the user, as further defined herein.

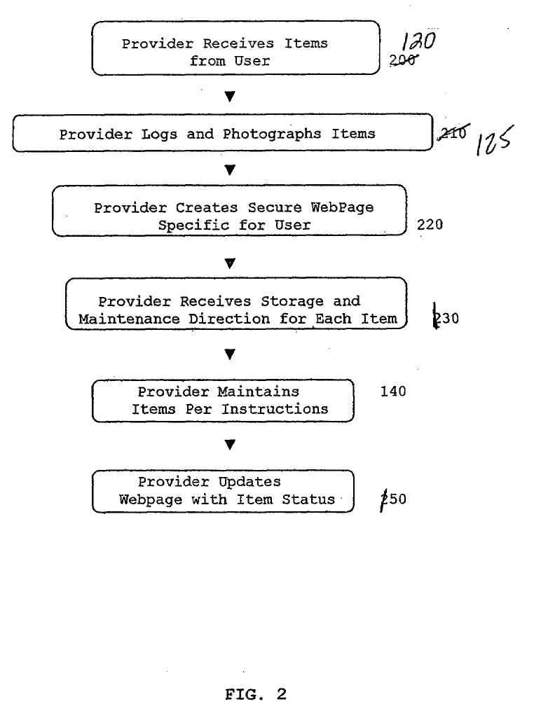

Preferably, as shown in FIG. 2, the virtual closet for each user is created by the provider, according to step 220, as a secure webpage, specific for the user, wherein a unique user identifier 60 and password 62, along with other security measures, as identified and deemed necessary, protect the contents of each virtual closet from unauthorized access. FIG. 6 provides one example of an initial user interface wherein input of user identifier 60 and password 62 could be requested.

Preferably, as noted above, the personal inventory present in each virtual closet is maintained, according to step 140, pursuant to directions received from the user in step 130, wherein preferably, the status of each item is updated by the provider, according to step 150, in order that the user may ascertain the availability of any item for use. It should be recognized that default directions for storage and maintenance of routine items may be provided for in system and method 10, wherein without specific instruction from a user regarding a particular item, cleaning and storage could follow the default parameters. For example, system and method 10 could be constructed in such a manner that a business suit could be dry-cleaned and stored hanging in an appropriate temperature and humidity, and a business shirt could be laundered, starched, and folded for subsequent packing, unless a user elects otherwise. Or, as another example, system and method 10 could be constructed in such a manner that a set of golf clubs could receive a cleaning of the heads, an examination and cleaning of the grips, a washing and replacement of the towel, and an inventory and replacement of balls and tees to a specified quantity. One skilled in the art should readily see that a variety of routines could be selectable, default regimens could be defined, and user-specific cleaning, maintenance, care and storage parameters, even those considered by some to be idiosyncratic, could all be accommodated within system and method 10.

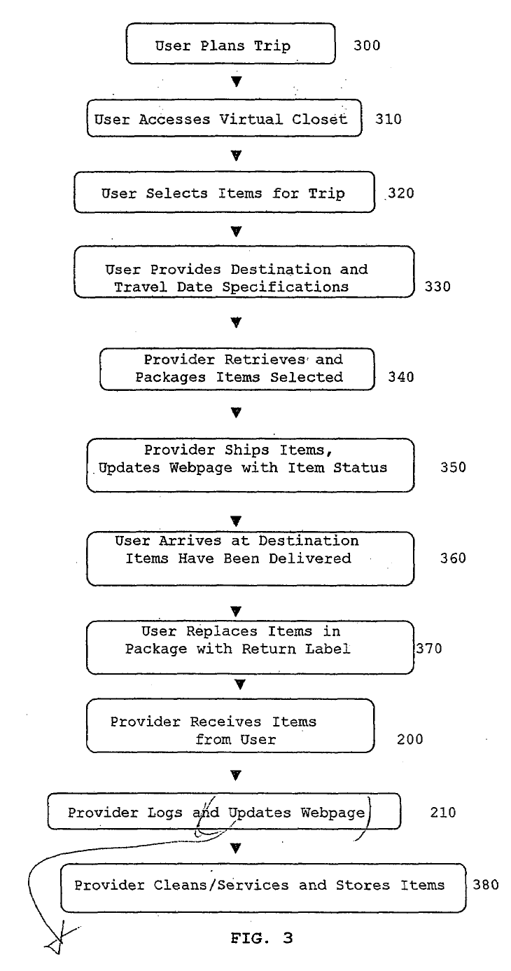

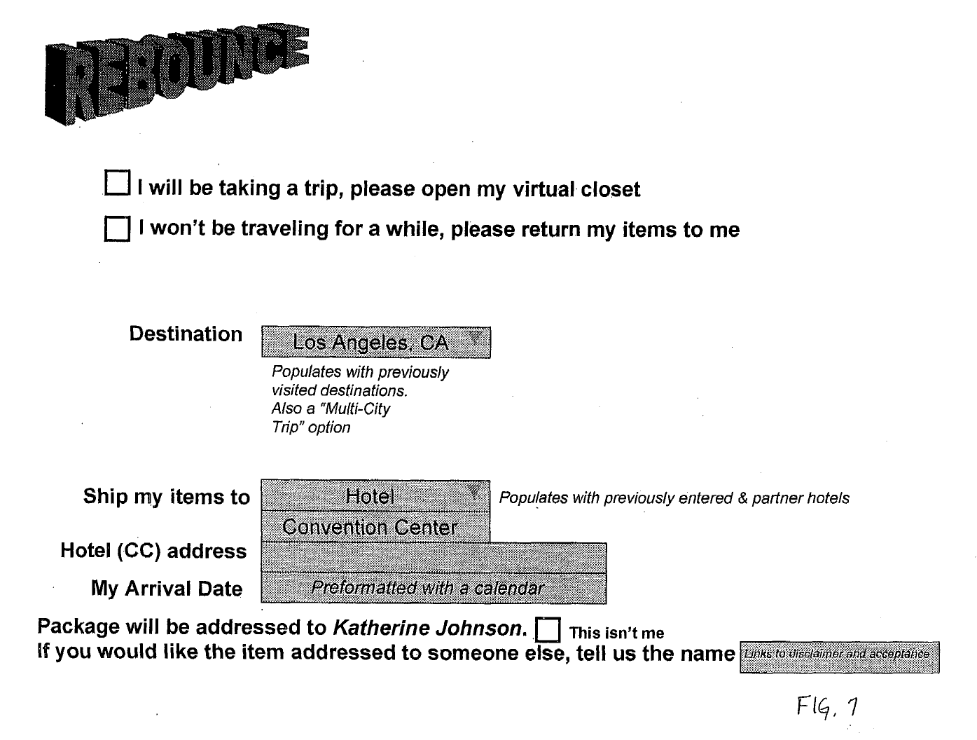

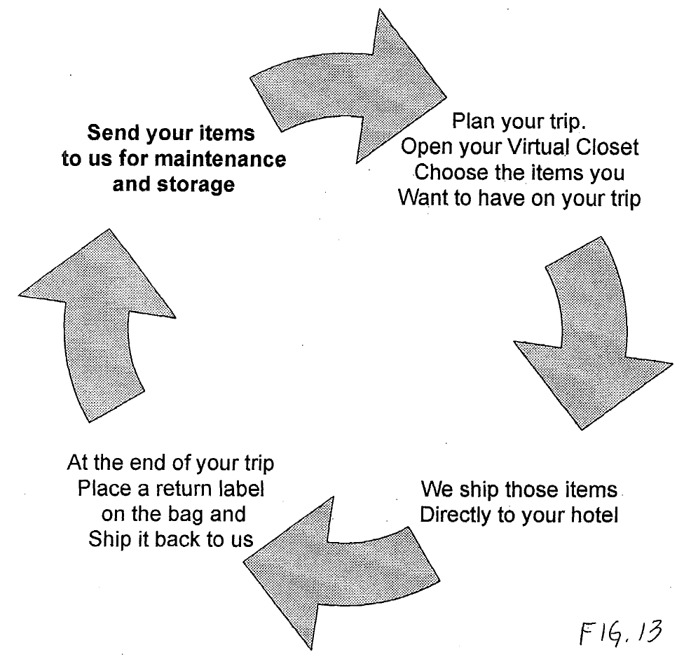

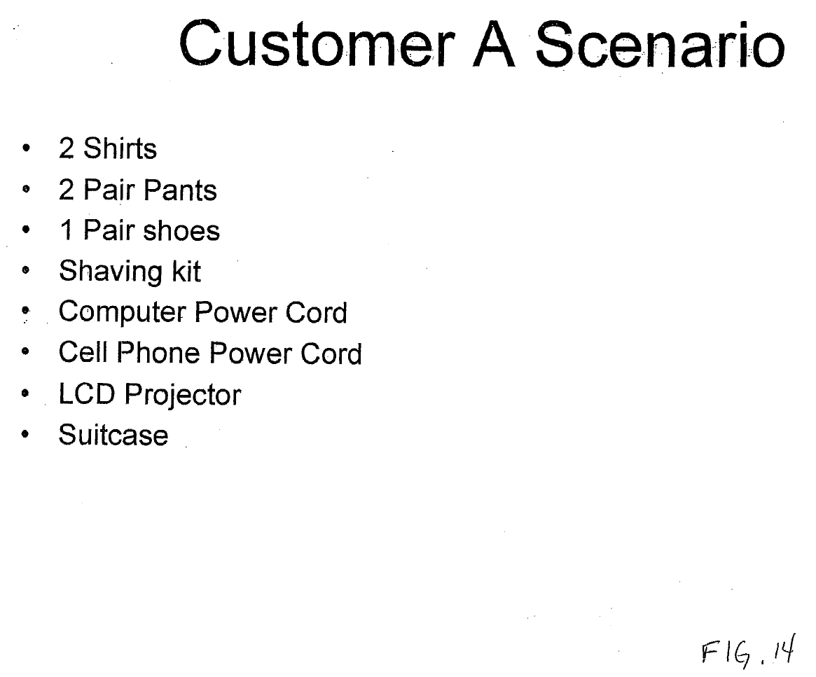

Referring now to the flowchart depicted in FIGS. 3 and 13, a member user plans a trip, step 300, and begins, at step 310, by accessing her virtual closet and selecting items that she would like to have waiting at her destination upon her arrival. An exemplary listing of such items is depicted in FIG. 14. The user interface depicted in FIG. 7 is exemplary of a preferred format for receiving directives from the user regarding her trip, wherein the user preferably provides destination and travel date specifications at step 330. Relevant input preferably includes destination city 200, identification of temporary residence 202, arrival date 204, and other delivery specifications 206.

Preferably, a user can select from drop-down menus, or can be provided with quick-fill selections for frequent or previously visited destination cities 200. Further, it is preferred that a user can select and/or enter multiple city destinations in order that items may be shipped consecutively from one destination to another without return to central storage facility 20. Preferably, temporary residence 202 is similarly definable via drop-down menus and/or quick-fill selections for frequent or previously visited locations. Also preferably, system and method 10 may be provided with reference information such that, for example, corresponding shipping address information may be automatically filled, requiring only confirmation by the user. Alternately, the user may specify a preferred delivery address.

At step 340, the service provider preferably physically retrieves the items selected by the user from her virtual closet and packages the items for shipping. Also preferably, the packaging contents includes return shipping label 210. According to preferred step 350, the service provider updates the user's personal inventory and the virtual closet display to indicate the status of each packed item, namely that each such item is unavailable for retrieval until return.

After traveling with ease to her destination, without being subjected to baggage check-in lines, the user arrives at her destination and finds the belongings that she selected from her virtual closet waiting for her, having been delivered preferably prior to her arrival, according to step 360. It is anticipated that the particulars of delivery arrival could be further specified by the user, wherein belongings could arrive at a particular time interval prior to the user's arrival, and/or could be deposited, or even unpacked and readily accessible in the user's hotel room. In order to accommodate such personal service, method and service 10 of the present invention could enlist cooperative service relationships with, for example, particular service-oriented hotel chains, wherein such partners could offer a charge-based service, could offer a gratuitous benefit to guests with concierge-level privileges, could offer a free service to preferred member guests, and/or could create any desirable and/or appropriate manner for such a service.

When the user is preparing for departure, she may repack her items and apply the preferably provided-for return shipping label 210, wherein presentation to bell service, or other hotel or center personnel can relieve the user, once again, of responsibility for her belongings. As noted hereinabove with respect to arrival and unpacking services, it is anticipated that in an alternate embodiment, packing services could similarly provided, wherein staff could repackage the user's belongings, in addition to arranging for shipping, depending upon the preference of the user.

Thereafter, at preferred step 200, the service provider again receives personal belongings from the user, and again takes an inventory thereof, arranging for appropriate care and/or maintenance at step 380, and updating the virtual closet accordingly, as per step 210.

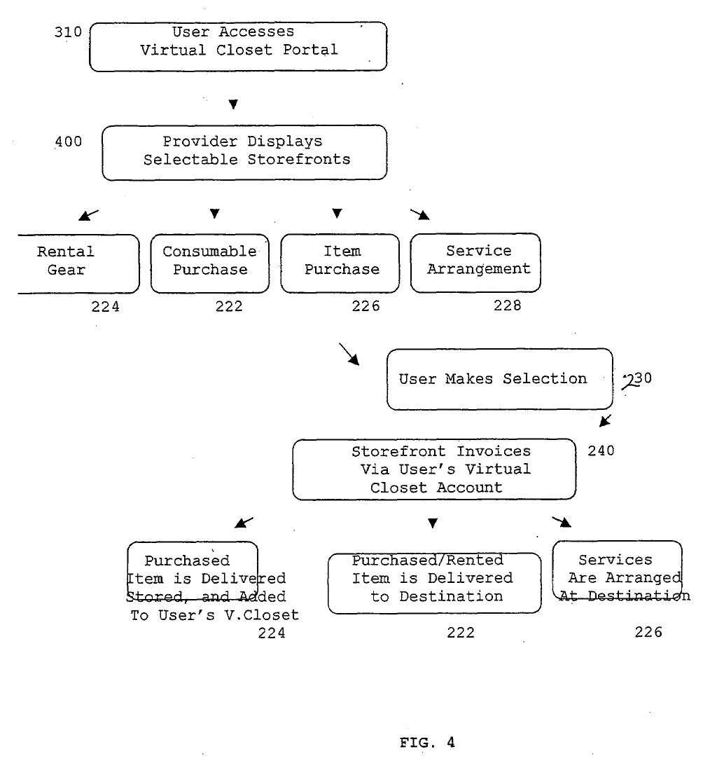

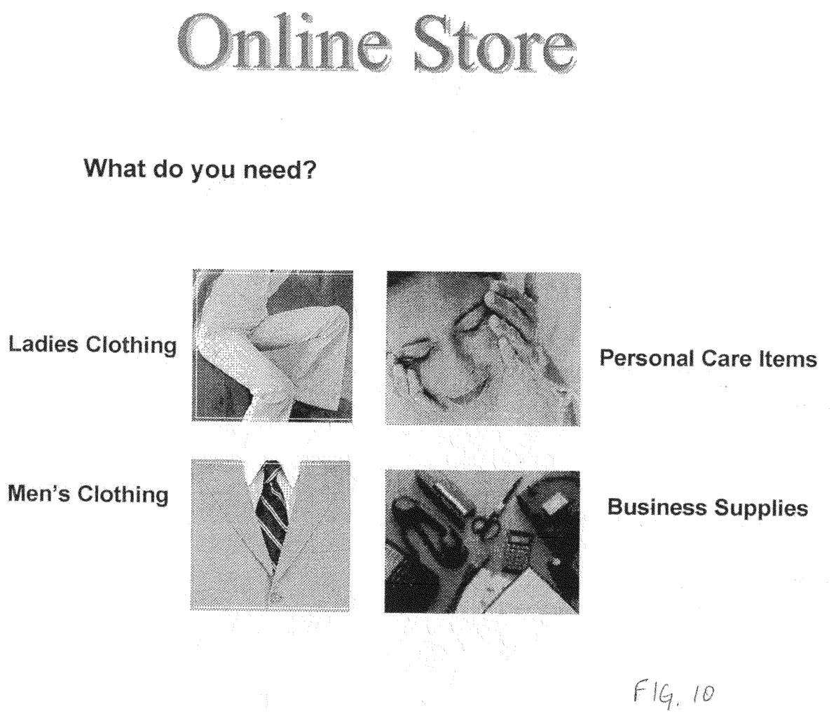

At any time, a user may access web portal 52 in order to view personal inventory and to check status thereof within his virtual closet. Further, care and maintenance parameters may be preferably defined and redefined at any time. Another preferred service of system and method 10, is the facilitation of restocking of items into a user's personal belonging inventory. Referring now to FIG. 4, a user accesses web portal 52, at step 310, and preferably advances to an interface of selectable storefronts 54, according to step 400, and preferred exemplary representation depicted in FIG. 10.

Selections are preferably offered according to generalized goods categories, according to step 222 for consumables and step 226 for general items, in order to facilitate ease of use, as seen in FIG. 10, such as, for exemplary purposes only, ladies clothing, men's clothing, business supplies, personal care items, and the like. Additionally, selections are also preferably offered according to generalized transaction categories, according to steps 224 and 226, such as for rental of items for use during a particular trip and/or arrangement of services, such as restaurant reservations, or limousine transportation, at a particular destination. One skilled in the art should readily recognize that the arrangement of the goods and services offered is amenable to many variations, none of which would depart from the intended scope of the present invention. Further, although particular goods and services are discussed herein, no limitation should be read to the type of goods and services that may be associated, either directly or indirectly, with system and method 10 of the present invention.

With respect to preferred step 230, wherein a user makes a selection from the offered goods and services, preferably, according to step 240, the user's membership account is utilized for billing and payment of the merchandise. Alternately, it should be understood that a third-party provider offering goods and/or services to user members of system and method 10 could invoice and collect payment for the related goods and/or services directly from the user members in lieu of processing via the provider of system and method 10. Preferably, irrespective of the billing method, if purchased goods are involved, such as, for exemplary purposes only, consumables, clothing, accessories, sporting goods, or other equipment or merchandise, delivery may be accomplished to a destination specified by a user, according to step 222, or delivery may present the purchased goods to storage facility 20, according to step 224, wherein the goods would be logged into the purchasing user's personal inventory and added to the related virtual closet for future selection. If rented goods are involved, although delivery could also be accomplished via the direction of the user, such goods would likely be rented for use at a particular destination, such as for exemplary purposes only, ski or scuba equipment rental for respective resort destinations, tuxedo rental for wear at a particular event, or an LCD projector or computer for a business project/presentation.

With respect to services, as with rental goods, likely such arrangements would be related to a travel event. As such, according to preferred step 226, the service would typically be arranged at the user's destination. Anticipated services could include, for example, dining and/or entertainment reservations, limousine arrangements, general travel arrangements, such as for air travel and hotel reservations, or any services that may be desired, whether travel related or not.

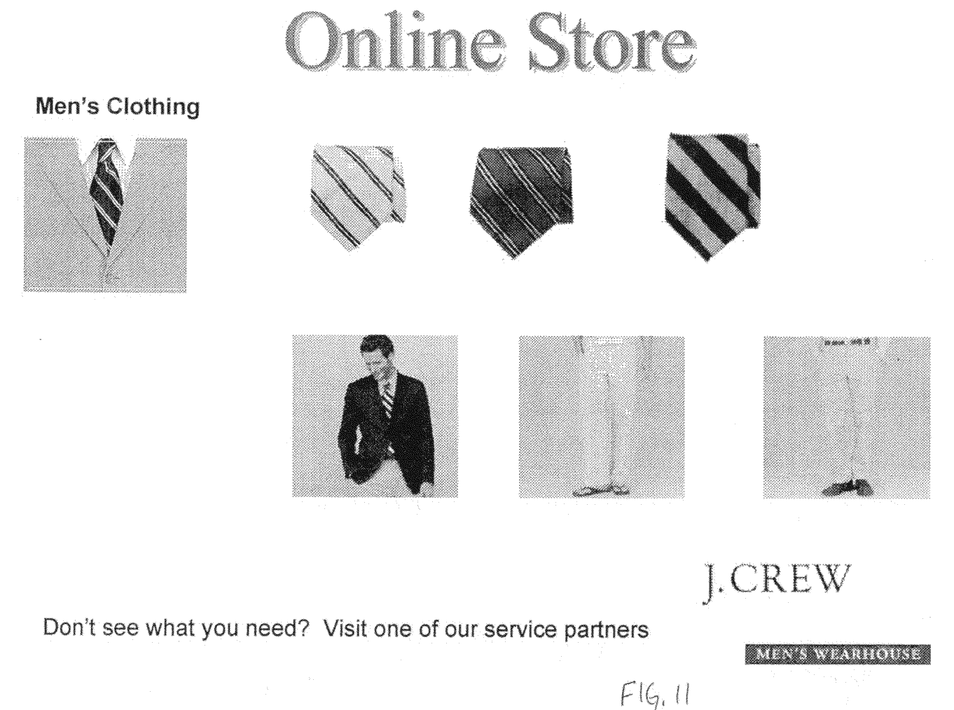

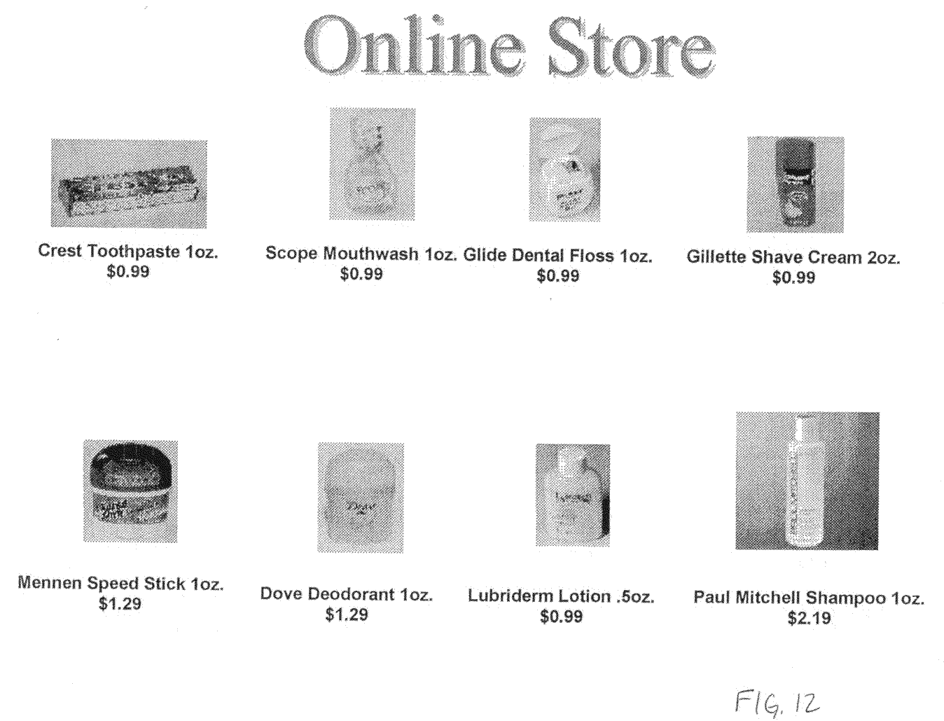

Regarding the goods and services preferably tangentially available to members of system and method 10, preferably, as depicted in FIG. 12, general consumables and sundries would be maintained in inventory and offered for sale by the provider of system and method 10, wherein such items would preferably be available on an ongoing and essentially immediate basis for inclusion in a virtual closet trip package for delivery to a particular destination, or for addition to a user's virtual closet inventory. Referring now to FIG. 11, according the preferred embodiment of the present invention, an assortment of basic necessity clothing items is preferably available on an ongoing and essentially immediate basis for inclusion in a virtual closet trip package, or for addition to a user's virtual closet inventory. Additionally, and also preferably, third party providers are linked to the online store, wherein selection and purchase of clothing or items may be integrated through the system, as previously discussed, with regards to shipping and/or payment processing.

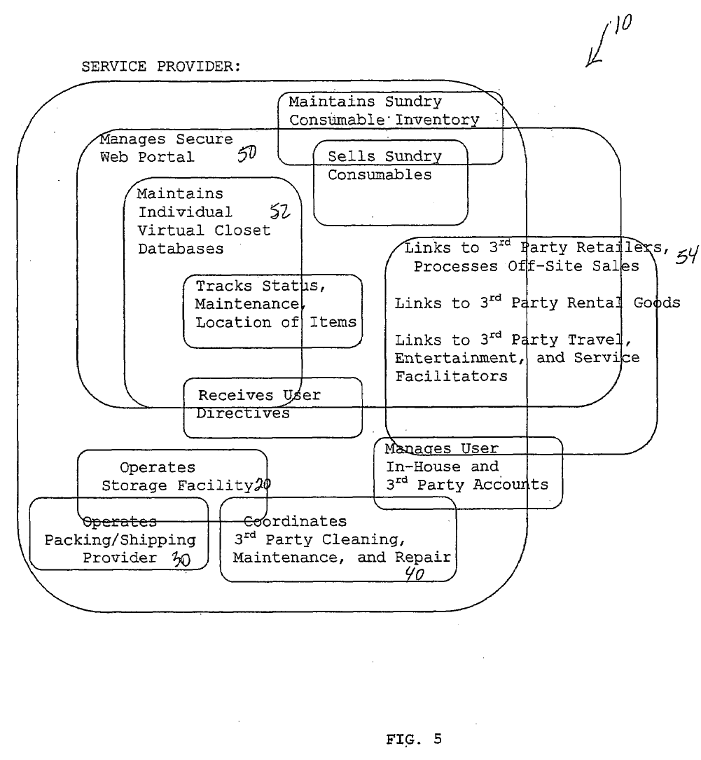

Service provider for system and method 10 provides a variety of interrelated services, the preferred relationship depicted in FIG. 5, wherein the service provider preferably manages secure web portal 50, operates storage facility 20, and maintains a sundry consumable inventory. As visually shown, each major function noted above is preferably related to other sub-functions, which, in turn, are related to one another. For example, the function of managing secure web portal 50 preferably includes maintaining individual virtual closet databases 52, wherein such maintenance preferably includes tracking the status, maintenance, and location of user items and receiving user directives regarding treatment of same.

The preferred function of maintaining a consumable sundry inventory is preferably related to another feature offered under the broad function of managing the secure portal 50, wherein the inventory of sundry consumables is preferably sold via the web portal. Additionally, with respect to the offering of goods and services of third party merchants, the management function of secure web portal 50 is related thereto, via the preferred linking and processing of shared data.

Finally, the storage facility operation function 20 preferably includes, sub-functions of operating as a packing and shipping provider 30 and coordinating for third party cleaning, maintenance and repair 40 of user-stored items. Further, each of the third party relationships is interrelated under the broad functionality of the service provider, wherein preferably, the service provider manages not only user in-house accounts and billing, but also third party accounts.

In an alternate embodiment of the present invention, one or more of the component services offered under system and method 10, for example, the packing and shipping component, the delivery component, the storage component, or any other feature and component of the system, could be provided via a relationship, exclusive or otherwise, with a known provider of such services, wherein an interrelated network of independent sub-providers could function cooperatively, with a web-based portrayal to the user of a single, unified provider. Many other such assorted arrangements could be utilized, or combinations thereof, wherein the ultimate goal of providing a system and method for organization and inventory of personal belongings, wherein off-site storage and maintenance alleviates the burden of hands-on care obligations, wherein network-based operation facilitates easy access from virtually any location, and wherein personal concierge-style shipping, delivery, and other services minimize the quantity of luggage, checked and hand-carried, for travelers, may be realized.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

What is claimed is:

1. A system for providing a network-facilitated storage and shipping service for user-owned articles, comprising the steps of:
a) associating at least one facility for receipt, storage, and retrieval of user-owned articles from a plurality of users;
b) developing a database comprising data on at least one user and data on user-owned articles received and stored at said at least one facility from said at least one user;
c) operating a web-portal wherein said at least one user can view said data on said user-owned articles stored at said facility by said at least one user, wherein said at least one user can select at least one item from said user-owned articles stored at said facility for retrieval, and wherein said at least one user can specify delivery parameters for said retrieved article;
d) associating at least one packing provider for packing said retrieved article;
e) associating at least one shipping provider for receiving said packed, retrieved article and shipping said packed, retrieved article according to said delivery parameters.

2. The system of claim 1, wherein said at least one packing provider includes a return shipping label with the packed, retrieved article, and further comprising the steps of:
f) receipt and use of said retrieved and delivered article by said at least one user;
g) repacking of said retrieved article and return to said facility via utilization of said return shipping label;
h) reentry of said retrieved article into said database of available user articles for selection by said at least one user.

3. The system of claim 1, wherein said data on user-owned articles received and stored at said at least one facility from said at least one user comprises an image and item status.

4. The system of claim 3, wherein said image is a photograph.

5. The system of claim 3, wherein said item status data comprises location and availability.

6. The system of claim 1, wherein said database further comprises data regarding user-directives for maintenance of at least one user-owned article.

7. The system of claim 1, wherein said at least one user can specify care and storage parameters for said stored user-owned articles.

8. The system of claim 1, wherein said packing provider operates at said facility.

9. The system of claim 1, wherein said at least one shipping provider operates at said facility.

10. The system of claim 1, further comprising the steps of:
f) associating at least one retail merchant for selling goods to said at least one user;
wherein said at least one user may purchase said goods via said web portal.

11. The system of claim 10, wherein said user may specify delivery parameters for said purchased goods via said web portal.

12. The system of claim 11, wherein said purchased goods may be delivered to said facility and may be entered into said at least one user's database of stored articles.

13. The system of claim 1, wherein said data on user-owned articles received and stored at said at least one facility from said at least one user comprises item descriptive information.

14. The system of claim 1, wherein the user-owned articles are selected from the group comprising personal belongings, toiletries, suits, ties, undergarments, overcoats, boots, shoes, golf clubs, skis, and skiwear.

15. The system of claim 6, wherein said user-directives for maintenance of at least one user-owned article are performed by a dry cleaner.

16. The system of claim 10, wherein said at least one retail merchant is selected from the group comprising a drugstore, market, grocery, pro-shop, sporting goods store, clothing store, department store, home goods store, electronics store, shoe store, and accessory store.

17. A goods management system, comprising:
a storage facility;
a shipping provider;
a goods maintenance provider; and
a network-accessible database, said database comprising data regarding goods stored at said storage facility, regarding shipping of the goods to and from said storage facility, and regarding the need for and status of maintenance by said good maintenance provided,
wherein goods are received from an individual user and stored at said storage facility, and
wherein network access to said database enables individual selection of stored goods for shipping to a destination upon a selected date.

18. The goods management system of claim 17, wherein the network access to said database further enables individual direction regarding maintenance for shipped goods returned to said storage facility.

19. The goods management system of claim 17, further comprising an electronic storefront, wherein the network access to said database further enables purchase of goods from said electronic storefront and selection of a shipping destination for said goods.

20. The goods management system of claim 19, wherein said shipping destination is selected from the group comprising: said storage facility, a specified travel destination, a home address, or a gift recipient's address.

21. The goods management system of claim 17, further comprising an electronic storefront, wherein the network access to said database further enables purchase of services from said electronic storefront.

22. The goods management system of claim 21, wherein said service is selected from the group comprising: rental of apparel, rental of sports equipment, concierge service, entertainment reservation and ticketing service, and travel reservation and ticketing service.
